(19) United States
(12) Patent Application Publication
(10) Pub. No.: US 2026/0149388 A1
(43) Pub. Date: May 28, 2026

(54) SWITCHING CONTROL CIRCUIT AND POWER SUPPLY CIRCUIT

(71) Applicant: FUJI ELECTRIC CO., LTD., Kawasaki-shi (JP)

(72) Inventor: Shoichi MURAKAMI, Matsumoto-city (JP)

(73) Assignee: FUJI ELECTRIC CO., LTD., Kawasaki-shi (JP)

(21) Appl. No.: 19/368,885

(22) Filed: Oct. 24, 2025

(30) Foreign Application Priority Data
Nov. 28, 2024 (JP) 2024-207535

(51) Int. Cl. H02M 7/217; H02M 1/00; H02M 1/42

(52) U.S. Cl. CPC H02M 7/217; H02M 1/0009; H02M 1/0054; H02M 1/4208

(57) ABSTRACT

A switching control circuit for a power supply circuit that includes a transistor controlling an inductor current flowing through an inductor. The switching control circuit controls switching of the transistor and including: a detection circuit detects whether the inductor current has reached a predetermined value; a timer circuit measures a time period after the inductor current has reached the predetermined value; and a driver circuit that turns on the transistor, in response to a number of times that the inductor current has reached the predetermined value reaching a predetermined number, and turn off the transistor, in response to an on-period having elapsed. The driver circuit further turns on the transistor, in response to the measured time period reaching a first predetermined time period and a second predetermined time period when an effective value of the AC voltage is a first level and a second level, respectively.

### CROSS-REFERENCE TO RELATED APPLICATION

This application claims priority pursuant to 35 U.S.C. § 119 from Japanese Patent Application No. 2024-207535, filed on Nov. 28, 2024, the content of which is incorporated herein by reference.

### BACKGROUND

### Technical Field

The present disclosure relates to a switching control circuit and a power supply circuit.

### Related Art

For example, some power factor correction circuits turn on a transistor based on the number of times an inductor current is zero after the transistor turns off. However, when a control circuit that controls the power factor correction circuit cannot detect that the inductor current has been zero, it cannot turn on the transistor, and therefore may forcibly turn on the transistor after a predetermined time period has elapsed (for example, Japanese Unexamined Patent Application Publication No. 2009-213280 and Japanese Unexamined Patent Application Publication No. 2017-017767).

Incidentally, when the transistor is forcibly turned on, the transistor cannot be driven appropriately, which may cause a switching loss of the transistor, distortion in an input current, and the like.

### SUMMARY

A first aspect of the present disclosure is switching control circuit for a power supply circuit that generates an output voltage from an alternating current (AC) voltage input thereto, the power supply circuit including an inductor configured to receive a rectified voltage corresponding to the AC voltage, and a transistor configured to control an inductor current flowing through the inductor, the switching control circuit being configured to control switching of the transistor of the power supply circuit, the switching control circuit including: a detection circuit configured to detect whether the inductor current has reached a predetermined value; a timer circuit configured to measure a time period after the inductor current has reached the predetermined value; and a driver circuit configured to turn on the transistor, in response to a number of times that the inductor current has reached the predetermined value reaching a predetermined number of times, and turn off the transistor, in response to an on-period that corresponds to the output voltage having elapsed, the driver circuit being further configured to turn on the transistor, in response to the measured time period reaching a first predetermined time period, when an effective value of the AC voltage is a first level, and turn on the transistor, in response to the measured time period reaching a second predetermined time period shorter than the first predetermined time period, when the effective value of the AC voltage is a second level higher than the first level.

A second aspect of the present disclosure is switching control circuit for a power supply circuit that generates an output voltage from an alternating current (AC) voltage input thereto, the power supply circuit including an inductor configured to receive a rectified voltage corresponding to the AC voltage, and a transistor configured to control an inductor current flowing through the inductor, the switching control circuit being configured to control switching of the transistor of the power supply circuit, the switching control circuit including: a detection circuit configured to detect whether the inductor current has reached a predetermined value; a timer circuit configured to measure a time period after the inductor current has reached the predetermined value; and a driver circuit configured to turn on the transistor, in response to a number of times that the inductor current has reached a predetermined value reaching a predetermined number of times or in response to the measured time period reaching a predetermined time period, and turn off the transistor. in response to an ON-period that corresponds to the output voltage having elapsed, the driver circuit being further configured to turn on the transistor at a timing at which a voltage between first and second electrodes of the transistor reaches a bottom, in response to the measured time period reaching the predetermined time period.

A third aspect of the present disclosure is a power supply circuit configured to generate an output voltage from an alternating current (AC) voltage, the power supply circuit including: an inductor configured to receive a rectified voltage corresponding to the AC voltage; a transistor configured to control an inductor current flowing through the inductor; and a switching control circuit configured to control switching of the transistor, the switching control circuit including a detection circuit configured to detect whether the inductor current has reached a predetermined value; a timer circuit configured to measure a time period after the inductor current has reached the predetermined value; and a driver circuit configured to turn on the transistor, in response to a number of times that the inductor current has reached the predetermined value reaching a predetermined number of times, and turn off the transistor, in response to an ON-period that corresponds to the output voltage having elapsed, the driver circuit being further configured to turn on the transistor, in response to the measured time period reaching a first predetermined time period, when an effective value of the AC voltage is a first level, and turn on the transistor, in response to the measured time period reaching a second predetermined time period shorter than the first predetermined time period, when the effective value of the AC voltage is a second level higher than the first level.

### BRIEF DESCRIPTION OF THE DRAWINGS

FIG. 1 is a diagram illustrating an example configuration of a power module 10.

FIG. 2 is a diagram illustrating an example configuration of a power factor correction IC 23.

FIG. 3 is a diagram illustrating an example configuration of a digital circuit 102a.

FIG. 4 is a diagram illustrating an example operation of the power factor correction IC 23.

FIG. 5A is a diagram illustrating an example of a period corresponding to a rectified voltage Vrec0.

FIG. 5B is a diagram illustrating an example of a period corresponding to the rectified voltage Vrec0.

FIG. 6A is a diagram illustrating an example of a time period Pa.

FIG. 6B is a diagram illustrating an example of a time period Pb.

FIG. 7 is a diagram illustrating an example configuration of a digital circuit 102b.

### DETAILED DESCRIPTION

At least the following matters are apparent from the description of the present specification and the accompanying drawings. Hereinafter, identical or equivalent components, members, and the like illustrated in the drawings are denoted by the same reference numerals, and a repeated description thereof may be omitted as appropriate.

### Present Embodiment

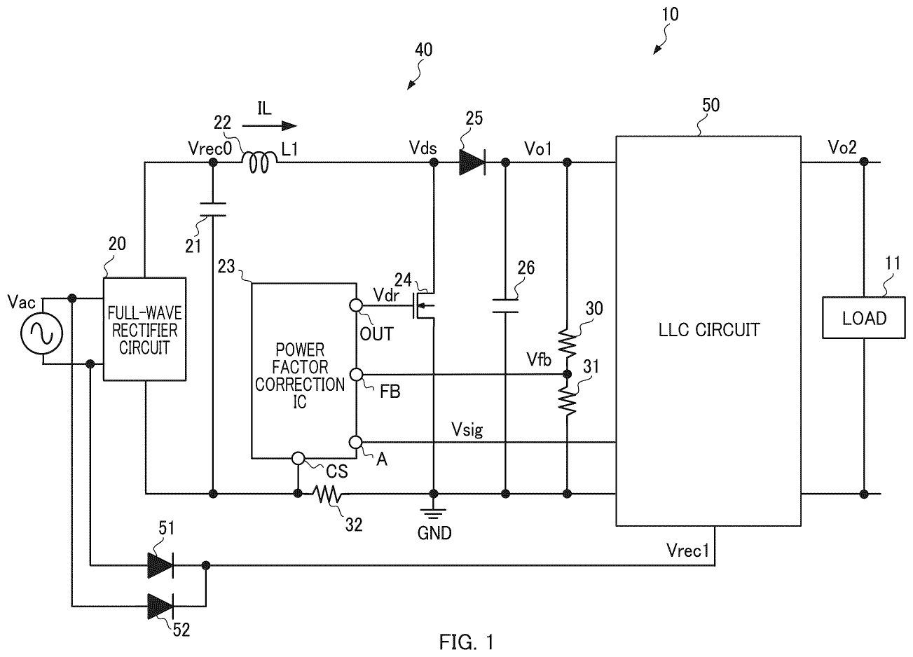

FIG. 1 is a diagram illustrating an example configuration of a power module 10, which is an embodiment of the present disclosure. The power module 10 is a circuit that generates an output voltage Vo2 from an AC voltage Vac of a commercial power supply.

### ===Example of Configuration of Power Module 10===

The power module 10 includes a full-wave rectifier circuit 20, capacitors 21 and 26, an inductor 22, a power factor correction IC 23, an NMOS transistor 24, diodes 25, 51, and 52, resistors 30 to 32, and an LLC circuit 50. A circuit of the power module 10 excluding the LLC circuit 50 and the diodes 51 and 52 includes a power factor correction circuit 40 and corresponds to a “power supply circuit.”

The full-wave rectifier circuit 20 full-wave rectifies an input predetermined AC voltage Vac and outputs the result, as an input voltage Vrec0, to the capacitor 21 and the inductor 22. The AC voltage Vac is, for example, a voltage having an effective value of 140 to 240 V and a frequency of 50 to 60 Hz. Hereinafter in the present embodiment, although a voltage is basically a potential difference with respect to a reference point (GND in the drawing), the AC voltage Vac indicates a voltage between terminals.

The capacitor 21 smooths the input voltage Vrec0, and the capacitor 26 configures a boost chopper circuit together with the inductor 22, the NMOS transistor 24, and the diode 25. Thus, a charging voltage of the capacitor 26 results in being a DC output voltage Vo1. When an inductor current IL flows in the direction of the arrow illustrated in the drawing, it is assumed that the inductor current IL is flowing in a positive direction.

The power factor correction IC 23 is an integrated circuit that controls switching of the NMOS transistor 24 such that a level of the output voltage Vo1 reaches a target level (for example, 400 V), while correcting an input power factor of the power module 10. Specifically, the power factor correction IC 23 drives the NMOS transistor 24 based on the inductor current IL flowing through the inductor 22 and the output voltage Vo1. Details of the power factor correction IC 23 are described later. The power factor correction IC 23 is provided with terminals CS, FB, OUT, and A. In the present embodiment, terminals other than the terminal CS and the like of the power factor correction IC 23 are omitted for convenience. The power factor correction IC 23 corresponds to a “switching control circuit.”

The NMOS transistor 24 is a power transistor that controls the inductor current IL to control power to the LLC circuit 50. In the present embodiment, the NMOS transistor 24 is an N-type MOS (Metal Oxide Semiconductor) transistor; however, the present disclosure is not limited thereto, and the NMOS transistor 24 may be another switching device such as a P-type MOS transistor or a bipolar transistor. The gate electrode of the NMOS transistor 24 is connected to the terminal OUT. A voltage on a drain electrode side of the NMOS transistor 24 is referred to as a voltage Vds, the drain electrode corresponds to a “first electrode,” and a source electrode corresponds to a “second electrode.”

The resistors 30 and 31 configures a voltage divider circuit that divides the output voltage Vo1, and generate a feedback voltage Vfb that is used when switching the NMOS transistor 24. The feedback voltage Vfb generated at a node to which the resistors 30 and 31 are connected is applied to the terminal FB.

The resistor 32 is a resistor for detecting the inductor current IL, with one end connected to the source electrode of the NMOS transistor 24 and the other end connected to the terminal CS. Accordingly, when the inductor current flows in the positive direction through the inductor 22, the voltage Vcs results in being a negative voltage.

The LLC circuit 50 is a load of the power factor correction circuit 40, and supplies power to a load 11 by outputting an output voltage Vo2 based on the output voltage Vo1. The LLC circuit 50 determines the effective value of the AC voltage Vac based on a full-wave rectified voltage Vrec1 generated by the diodes 51 and 52. The LLC circuit 50 outputs a low-level (hereinafter, referred to as low or low level) signal Vsig when the effective value of the AC voltage Vac is less than ½ of the output voltage Vo1 (that is, 200 V) (for example, 100 V). On the other hand, the LLC circuit 50 outputs a high-level (hereinafter, referred to as high or high level) signal Vsig when the effective value of the AC voltage Vac exceeds ½ of the output voltage Vo1 (that is, 200 V). The signal Vsig is input to the terminal A of the power factor correction IC 23.

### ===Example of Configuration of Power Factor Correction IC 23===

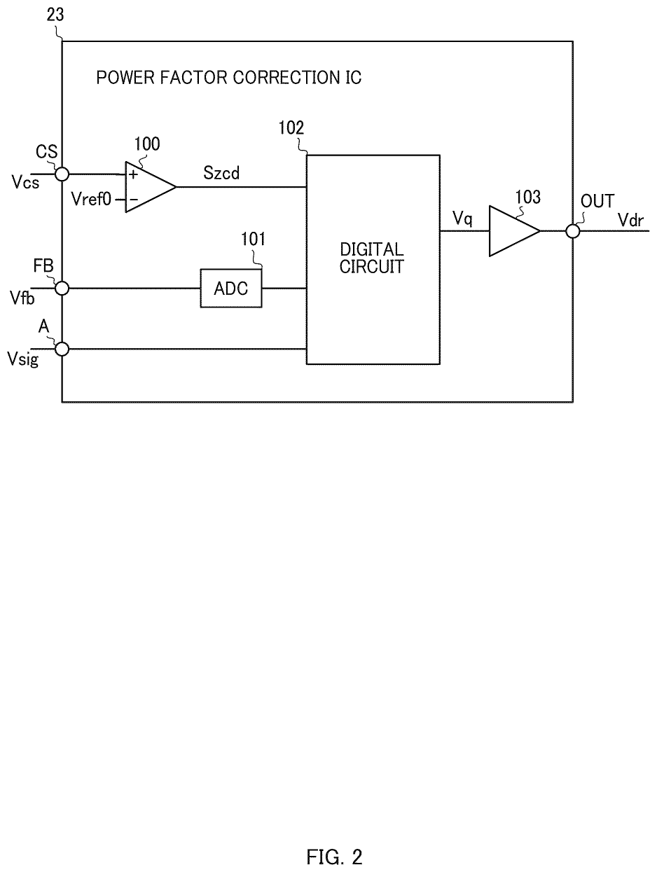

FIG. 2 is a diagram illustrating an example configuration of the power factor correction IC 23. The power factor correction IC 23 includes a comparator 100, an AD converter (ADC: Analog-to-Digital Converter) 101, a digital circuit 102, and a buffer circuit 103.

The comparator 100 detects whether the inductor current IL has reached a predetermined value (for example, approximately zero, hereinafter referred to as “zero”). Specifically, the comparator 100 detects a timing at which the inductor current IL reaches zero, and outputs a high signal Szcd when the voltage Vcs becomes higher than a reference voltage Vref0. On the other hand, the comparator 100 outputs a low signal Szcd when the voltage Vcs is lower than the reference voltage Vref0. The reference voltage Vref0 is set such that the comparator 100 outputs the high signal Szcd when the inductor current IL reaches approximately zero. The comparator 100 corresponds to a “detection circuit.”

The AD converter 101 converts the feedback voltage Vfb into a digital value. Hereinafter, the feedback voltage Vfb converted into a digital value is also referred to as the feedback voltage Vfb.

The digital circuit 102 is a circuit that outputs a driving signal Vq for driving the NMOS transistor 24 based on the feedback voltage Vfb and the signal Szcd. The digital circuit 102 is a wired-logic-type logic circuit that executes various operations, and includes, for example, logic gates, flip-flops, and a memory. Details of the digital circuit 102 are described later.

The buffer circuit 103 is a driver circuit that drives the NMOS transistor 24 based on the driving signal Vq. Specifically, the buffer circuit 103 outputs a drive voltage Vdr that turns on the NMOS transistor 24 when the digital circuit 102 outputs a high signal Vq. On the other hand, the buffer circuit 103 outputs a drive voltage Vdr that turns off the NMOS transistor 24 when the digital circuit 102 outputs a low signal Vq.

===Example of Configuration of Digital Circuit 102a===

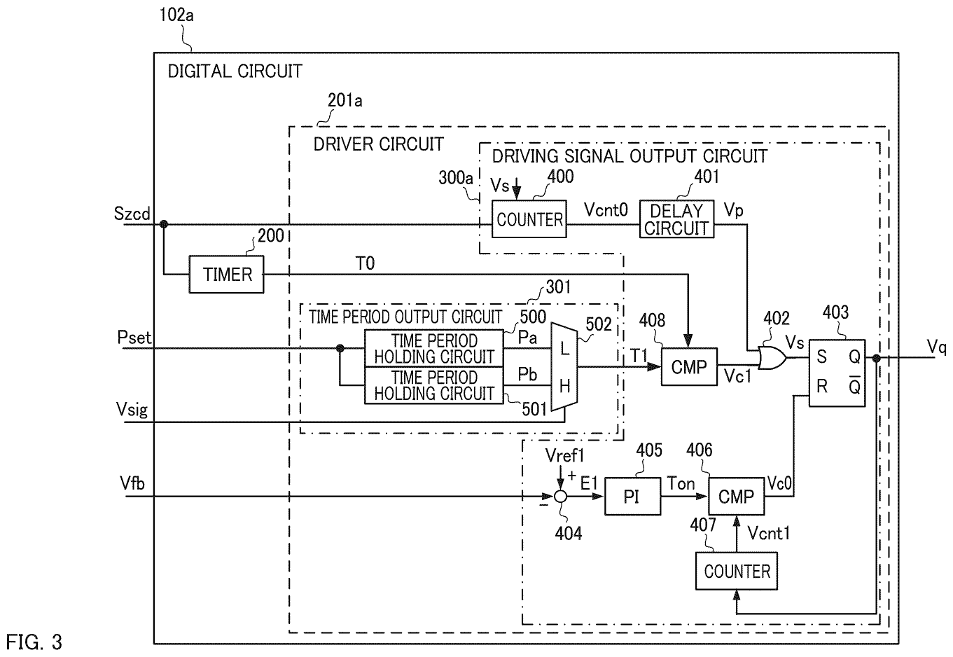

FIG. 3 is a diagram illustrating an example configuration of a digital circuit 102a. The digital circuit 102a outputs the driving signal Vq based on the inductor current IL and the feedback voltage Vfb. The digital circuit 102a includes a timer 200 and a driver circuit 201a.

The timer 200 times a time period after the inductor current IL reaches the predetermined value, that is, a time period after the comparator 100 outputs the high signal Szcd. Specifically, when the voltage Vcs becomes higher than the reference voltage Vref0 and the comparator 100 outputs the high signal Szcd, the timer 200 is reset, then times a time period, and outputs a time period TO indicating the time period. The timer 200 corresponds to a “timer circuit.”

The driver circuit 201a outputs the driving signal Vq based on the signal Szcd, the feedback voltage Vfb, and the signal Vsig. Specifically, the driver circuit 201a outputs a high driving signal Vq when the number of times the inductor current IL has reached the predetermined value reaches a predetermined number of times, that is, when the number of times the high signal Szcd has been input reaches a predetermined number of times. On the other hand, when the next high signal Szcd is not input even after a predetermined time period T1 has elapsed after the high signal Szcd was input, the driver circuit 201a outputs a high driving signal Vq based on a time period Pset obtained from an external source and the signal Vsig. The driver circuit 201a outputs a low driving signal Vq when an ON-period Ton corresponding to the feedback voltage Vfb has elapsed. The driver circuit 201a includes a driving signal output circuit 300a and a time period output circuit 301.

The driving signal output circuit 300a outputs the driving signal Vq based on the signal Szcd, the feedback voltage Vfb, and the time period T1. Specifically, when the number of times the high signal Szcd has been input does not reach the predetermined number of times (for example, it cannot be detected that the inductor current IL reaches zero for the second time or thereafter), the driving signal output circuit 300a outputs a high driving signal Vq when the time period T1 has elapsed after the high signal Szcd was input. That is, the driving signal output circuit 300a forcibly turns on the NMOS transistor 24 when the time period T1 elapses without the high signal Szcd being detected. The driving signal output circuit 300a includes counters 400 and 407, a delay circuit 401, an OR circuit 402, an SR flip-flop 403, a subtractor 404, a PI controller 405, and comparators 406 and 408.

The counter 400 counts the number of times the high signal Szcd has been input, and outputs the result as a count value Vcnt0.

The delay circuit 401 outputs a pulse signal Vp after a delay time Tzcd when the count value Vcnt0 reaches a predetermined number of times.

The OR circuit 402 calculates a logical sum of the pulse signals Vp and Vc1, and outputs the result as a pulse signal Vs.

The SR flip-flop 403 outputs a high driving signal Vq when the pulse signal Vs is input, and outputs a low signal Vq when a pulse signal Vc0 (described later) is input.

The subtractor 404 subtracts the feedback voltage Vfb from a reference voltage Vref1 that serves as a reference for a target level of the output voltage Vo1 (for example, 400 V), and calculates an error E1 between the reference voltage Vref1 and the feedback voltage Vfb.

The PI controller 405 performs PI control based on the error E1, and generates ON-period Ton for making the level of the feedback voltage Vfb match the level of the reference voltage Vref1. The voltage level of the output voltage Vo1 is maintained at the target level, the feedback voltage Vfb is also constant, and as a result, the ON-period Ton is also substantially constant. When the NMOS transistor 24 is turned on for a constant period, a peak value of the inductor current changes according to the rectified voltage Vrec0. A time period, from when the NMOS transistor 24 turns off until when the inductor current IL is zero, becomes longer as the peak value of the inductor current IL increases. Thus, a switching frequency of the NMOS transistor 24 changes according to the voltage level of the rectified voltage Vrec0.

The comparator 406 compares the ON-period Ton with a count value Vcnt1 (described later) indicating a time period after the high driving signal Vq is output, and outputs the pulse signal Vc0 when the count value Vcnt1 reaches the ON-period Ton.

The counter 407 counts a time period during which the high driving signal Vq is being output, and outputs the result as the count value Vcnt1.

The comparator 408 compares the time period TO with the time period T1, and outputs the pulse signal Vc1 when the time period TO exceeds the time period T1.

The time period output circuit 301 outputs the time period T1 based on the time period Pset and the signal Vsig. Specifically, when a low signal Vsig is input indicating that the effective value of the AC voltage Vac is less than 200 V (for example, 100 V), the time period output circuit 301 outputs a time period Pa as the time period T1. On the other hand, when a high signal Vsig is input indicating that the effective value of the AC voltage Vac exceeds 200 V, the time period output circuit 301 outputs a time period Pb, which is shorter than the time period Pa, as the time period T1. The time period output circuit 301 includes time period holding circuits 500 and 501, and a selector 502. The level of the effective value of the AC voltage of less than 200 V corresponds to a “first level,” and the level of the effective value of the AC voltage exceeding 200 V corresponds to a “second level.”

The time period holding circuit 500 outputs the time period Pa corresponding to the time period Pset. The time period holding circuit 501 outputs the time period Pb corresponding to the time period Pset. The time period Pa corresponds to a “first predetermined time period,” and the time period Pb corresponds to a “second predetermined time period.”

When the low signal Vsig is input, the selector 502 outputs the time period Pa as the time period T1, and when the high signal Vsig is input, the selector 502 outputs the time period Pb as the time period T1.

### ===Example of Operation of Power Factor Correction IC 23===

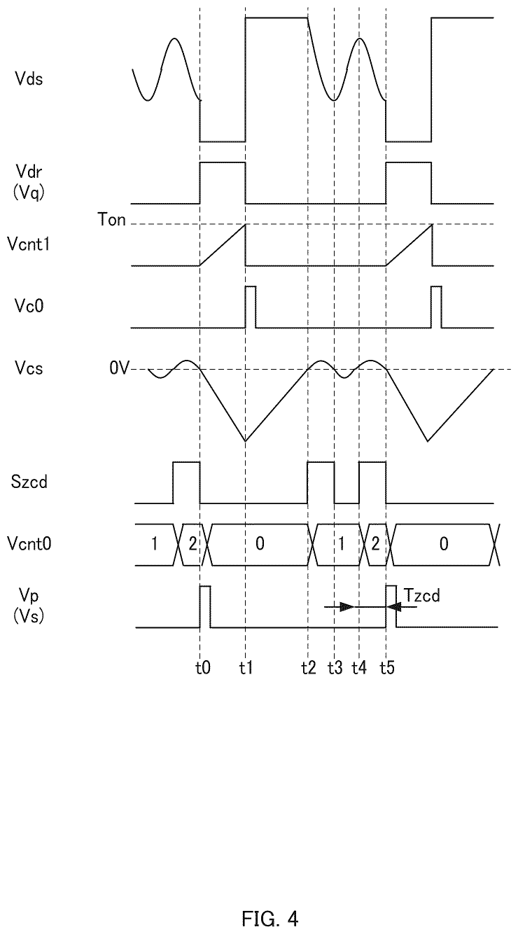

FIG. 4 is a diagram illustrating an example operation of the power factor correction IC 23. In FIG. 4, it is assumed that the predetermined number of times is two.

At time to, the power factor correction IC 23 outputs the drive voltage Vdr that turns on the NMOS transistor 24. The counter 407 starts counting. When the NMOS transistor 24 turns on, the inductor current IL flows in the positive direction, and the voltage Vcs starts to decrease. The counter 400 is reset.

At time t1, when the count value Vcnt1 is equal to the ON-period Ton, the comparator 406 outputs the pulse signal Vc0. The inductor current IL then begins to decrease, and the voltage Vcs begins to rise. When the NMOS transistor 24 turns off, the diode 25 turns on, and the drain-source voltage Vds of the NMOS transistor 24 rises to a voltage level that corresponds to the output voltage Vo1.

At time t2, when the inductor current IL is zero, the diode 25 turns off, and the voltage Vds begins to decrease. The voltage Vcs becomes approximately zero volts, and the comparator 100 outputs the high signal Szcd. The counter 400 is incremented based on the high signal Szcd, setting the count value Vcnt0 to “1.” Thereafter, a parasitic capacitor of the NMOS transistor 24 and the inductor 22 cause a resonant operation corresponding to a parasitic capacitance value of the NMOS transistor 24 and an inductance value of the inductor 22.

At time t3, at which the voltage Vds reaches a minimum value, the inductor current IL is zero. The comparator 100 then outputs the low signal Szcd.

At time t4, at which when the voltage Vds reaches a maximum value, the inductor current IL is zero, and the comparator 100 outputs the high signal Szcd. The counter 400 then is incremented based on the high signal Szcd, setting the count value Vcnt0 to “2.” The count value Vcnt0 has reached “2,” and thus the delay circuit 401 measures the delay time Tzcd.

At time t5, at which the delay time Tzcd has elapsed from time t4, the delay circuit 401 outputs the pulse signal Vp, and the power factor correction IC 23 outputs the drive voltage Vdr that turns on the NMOS transistor 24. At this time, because the delay time Tzcd is set to a time period from when the inductor current IL becomes zero until the voltage Vds reaches the minimum value, the switching loss of the NMOS transistor 24 is reduced. Further, as described above, the minimum value of the voltage Vds is referred to as a “bottom.” Thereafter, a similar or the same operation is repeated.

### ===Change in Resonant Period due to Difference in Effective Value of AC Voltage Vac===

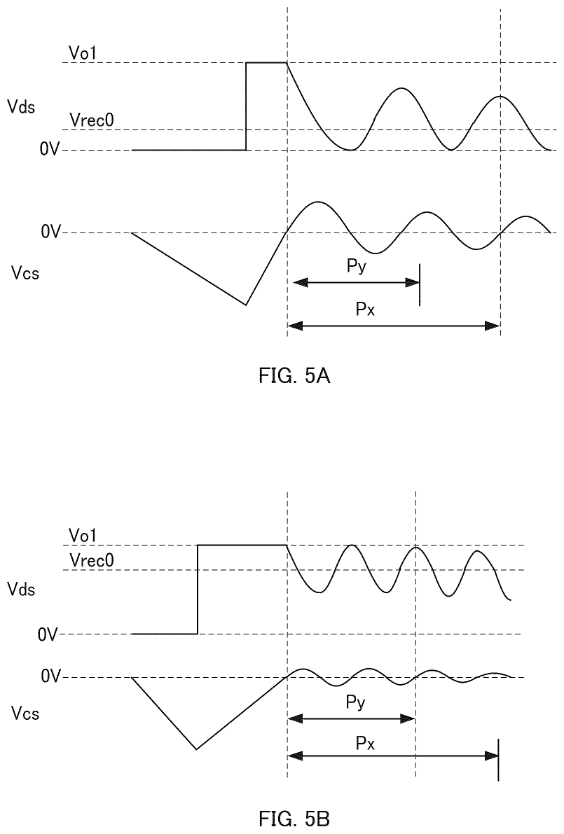

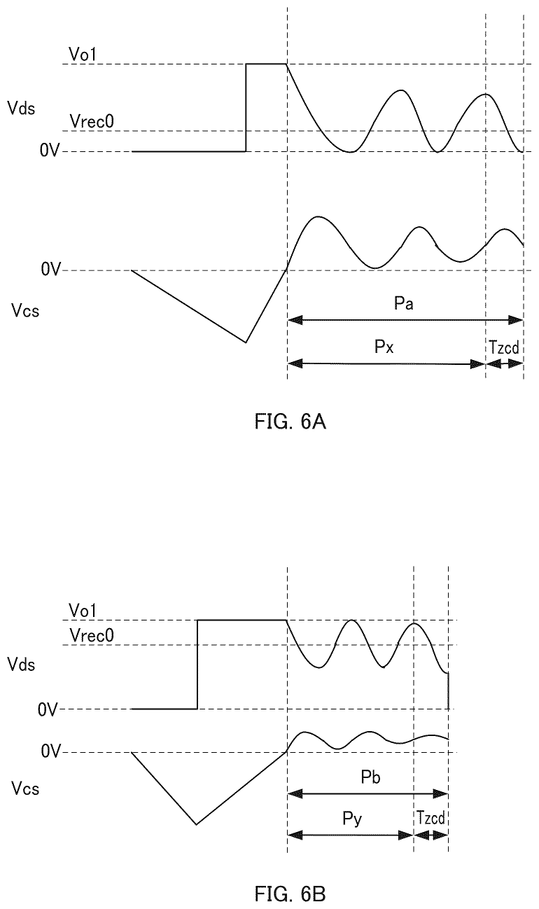

FIG. 5A and FIG. 5B are diagrams illustrating an example of a period corresponding to the effective value of the AC voltage Vac. FIG. 6A and FIG. 6B are diagrams illustrating an example of the time periods Pa and Pb. FIG. 5A and FIG. 6A are example resonant operations when the voltage level of the rectified voltage Vrec0 is less than ½ of the output voltage Vo1, and FIG. 5B and FIG. 6B are example resonant operations when the voltage level of the rectified voltage Vrec0 exceeds ½ of the output voltage Vo1.

As illustrated in FIG. 5A, a resonant period when the voltage level of the rectified voltage Vrec0 is less than ½ of the output voltage Vo1 is referred to as a time period Px. In FIG. 5A, the time period Px is illustrated as showing a period for two cycles.

On the other hand, as illustrated in FIG. 5B, if a resonant period when the voltage level of the rectified voltage Vrec0 exceeds ½ of the output voltage Vo1 is referred to as a time period Py, the amount of resonant current is smaller the case of FIG. 5B, that is, a fluctuation range of the voltage Vcs after the NMOS transistor 24 turns off is smaller, and thus the time period Py is shorter than the time period Px. In FIG. 5B, the time period Py is illustrated as showing a period for two cycles. Accordingly, if the time period T1 is fixed to a period that corresponds to either the time period Px or Py, it may not be possible to turn on the NMOS transistor 24 at a “bottom” depending on the voltage level of the rectified voltage Vrec0. In some cases, the NMOS transistor 24 may be turned on at a timing when the voltage Vds reaches a maximum value, which may lead to an increase in switching loss and an increase in power consumption.

Therefore, in the present embodiment, as illustrated in FIG. 6A, the time period Pa is a time period obtained by adding the delay time Tzcd to the time period Px, and as illustrated in FIG. 6B, the time period Pb is a time period obtained by adding the delay time Tzcd to the time period Py. Each of the time periods Pa and Pb is set to be a time period from when the NMOS transistor 24 turns off until the voltage Vds between the drain and source of the NMOS transistor reaches the “bottom.” In FIG. 6A and FIG. 6B, a “bottom” number for forced turn-on is set to a number greater than a predetermined number of times (for example, two times). This is because if the predetermined number of times and the “bottom” number for forced turn-on are the same, a forced turn-on may occur before the high signal Szcd is detected the predetermined number of times, when the high signal Szcd is normally detected.

From the above, even if the high signal Szcd cannot be detected for the second time or thereafter, the NMOS transistor 24 can be turned on at a “bottom,” and the switching loss of the NMOS transistor 24 is reduced. This makes it possible to provide a switching control circuit that can appropriately drive a transistor.

### Modification Example

===Example of Configuration of Digital Circuit 102b===

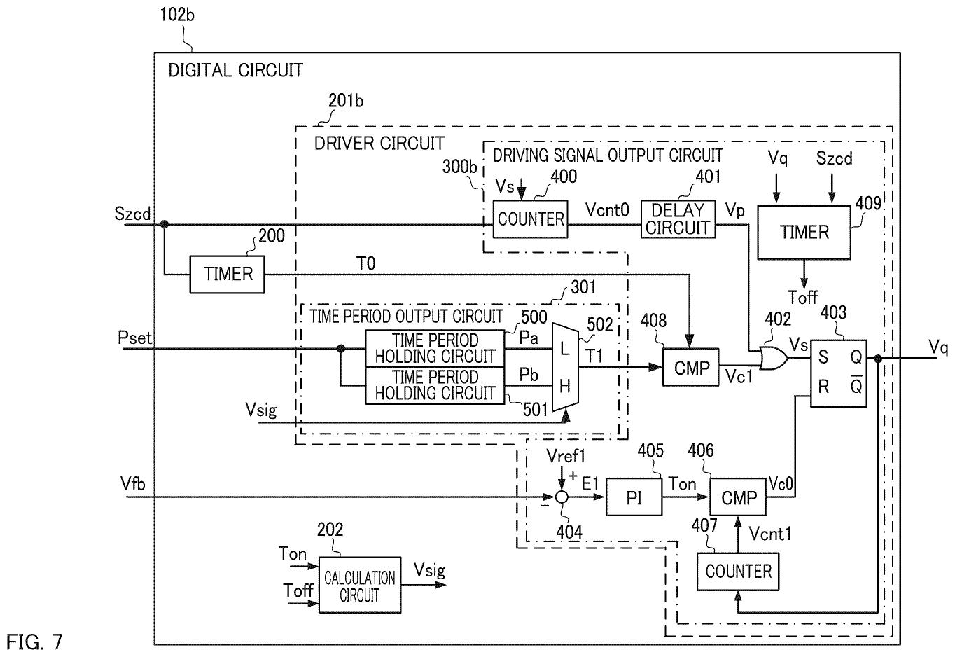

FIG. 7 is a illustrating diagram an example configuration of a digital circuit 102b. Similarly to the digital circuit 102a, the digital circuit 102b outputs the driving signal Vq based on the inductor current IL and the feedback voltage Vfb. The digital circuit 102b includes the timer 200, a driver circuit 201b, and a calculation circuit 202.

The driver circuit 201b outputs the driving signal Vq based on the signal Szcd, the feedback voltage Vfb, and the signal Vsig. The driver circuit 201b includes a driving signal output circuit 300b and the time period output circuit 301.

The driving signal output circuit 300b outputs the driving signal Vq based on the signal Szcd, the feedback voltage Vfb, and the time period T1. The driving signal output circuit 300b includes the counters 400 and 407, the delay circuit 401, the OR circuit 402, the SR flip-flop 403, the subtractor 404, the PI controller 405, the comparators 406 and 408, and a timer 409.

The timer 409 measures an OFF-period Toff. Specifically, the timer 409 starts measuring when a low driving signal Vq is input, ends measuring when the high signal Szcd is input, and outputs the measured period as the OFF-period Toff.

The calculation circuit 202 calculates a voltage level of the rectified voltage Vrec0 (that is, the AC voltage Vac) based on the ON-period Ton and the OFF-period Toff, and outputs the signal Vsig based on a calculation result. Specifically, the calculation circuit 202 calculates the rectified voltage Vrec0 based on the following expression, and determines the effective value of the AC voltage Vac based on the rectified voltage Vrec0.

$$Vrec 0 = ( Toff / ( Ton + Toff ) ) \times Vol \qquad Expression ( 1 )$$

The calculation circuit 202 then outputs the low signal Vsig when the effective value of the AC voltage Vac is less than ½ of the output voltage Vo1 (that is, 200 V) (for example, 100 V). On the other hand, the calculation circuit 202 outputs the high signal Vsig when the effective value of the AC voltage Vac exceeds ½ of the output voltage Vo1 (that is, 200 V). The driver circuit 201b then operates similarly to the driver circuit 201a based on the signal Vsig. The time period output circuit 301 corresponds to an “output circuit,” and the driving signal output circuit 300b corresponds to an “on-off circuit.”

### SUMMARY

The power module 10 of the present embodiment has been described above. The power factor correction IC 23 includes the comparator 100, the timer 200, and the driver circuit 201a. When the comparator 100 does not output the high signal Szcd the second time or thereafter after the NMOS transistor 24 is turned off, the power factor correction IC 23 turns on the NMOS transistor 24 in either the time period Pa or Pb based on the signal Vsig that corresponds to the effective value of the AC voltage Vac. This makes it possible to provide a switching control circuit that can appropriately drive a transistor.

The time periods Pa and Pb are each set according to the effective value of the AC voltage Vac so as to turn on the NMOS transistor 24 at a “bottom.” This reduces the switching loss of the NMOS transistor 24.

The power factor correction IC 23 includes the calculation circuit 202, and the driver circuit 201b includes the driving signal output circuit 300b and the time period output circuit 301. Accordingly, even if a load that does not have a function of determining the effective value of the AC voltage Vac, such as the LLC circuit 50, is connected downstream of the power factor correction circuit 40, the power factor correction IC 23 can appropriately drive the transistor.

The power factor correction IC 23 includes the comparator 100, the timer 200, and the driver circuit 201a. This makes it possible to provide a switching control circuit that can appropriately drive a transistor.

The power factor correction circuit 40 includes the inductor 22, the NMOS transistor 24, and the power factor correction IC 23, and the power factor correction IC 23 includes the comparator 100, the timer 200, and the driver circuit 201a. Accordingly, the power factor correction circuit 40 using the power factor correction IC 23 can reduce the switching loss of the NMOS transistor 24, thereby becoming a power supply circuit with excellent power efficiency.

The present disclosure is directed to provision of a switching control circuit that can appropriately drive a transistor.

According to the present disclosure, it is possible to provide a switching control circuit that can appropriately drive a transistor.

The above-described embodiment is for facilitating the understanding of the present disclosure and is not for interpreting the present disclosure in a limited manner. It goes without saying that the present disclosure can be changed or improved without departing from the spirit thereof, and that the present disclosure includes equivalents thereof.

What is claimed is:

1. A switching control circuit for a power supply circuit that generates an output voltage from an alternating current (AC) voltage input thereto, the power supply circuit including
an inductor configured to receive a rectified voltage corresponding to the AC voltage, and
a transistor configured to control an inductor current flowing through the inductor,
the switching control circuit being configured to control switching of the transistor of the power supply circuit, the switching control circuit comprising:
a detection circuit configured to detect whether the inductor current has reached a predetermined value;
a timer circuit configured to measure a time period after the inductor current has reached the predetermined value; and
a driver circuit configured to
turn on the transistor, in response to a number of times that the inductor current has reached the predetermined value reaching a predetermined number of times, and
turn off the transistor, in response to an on-period that corresponds to the output voltage having elapsed,
the driver circuit being further configured to
turn on the transistor, in response to the measured time period reaching a first predetermined time period, when an effective value of the AC voltage is a first level, and
turn on the transistor, in response to the measured time period reaching a second predetermined time period shorter than the first predetermined time period, when the effective value of the AC voltage is a second level higher than the first level.

2. The switching control circuit according to claim 1, wherein
each of the first and second predetermined time periods is a time period from when the transistor is turned off until when a voltage between first and second electrodes of the transistor reaches a bottom.

3. The switching control circuit according to claim 1, further comprising:
a calculation circuit configured to calculate the AC voltage, based on the ON-period of the transistor and an OFF-period of the transistor, wherein
the driver circuit includes:
an output circuit configured to, based on a calculation result of the calculation circuit,
output the first predetermined time period, when the effective value of the AC voltage is the first level, and
output the second predetermined time period, when the effective value of the AC voltage is the second level, and
an on-off circuit configured to
turn on the transistor, in response to the measured time period reaching the first or second predetermined time period that is output from the output circuit, and
turn off the transistor, in response to the ON-period having elapsed.

4. A switching control circuit for a power supply circuit that generates an output voltage from an alternating current (AC) voltage input thereto, the power supply circuit including
an inductor configured to receive a rectified voltage corresponding to the AC voltage, and
a transistor configured to control an inductor current flowing through the inductor,
the switching control circuit being configured to control switching of the transistor of the power supply circuit, the switching control circuit comprising:
a detection circuit configured to detect whether the inductor current has reached a predetermined value;
a timer circuit configured to measure a time period after the inductor current has reached the predetermined value; and
a driver circuit configured to
turn on the transistor, in response to a number of times that the inductor current has reached a predetermined value reaching a predetermined number of times or in response to the measured time period reaching a predetermined time period, and
turn off the transistor, in response to an ON-period that corresponds to the output voltage having elapsed,
the driver circuit being further configured to turn on the transistor at a timing at which a voltage between first and second electrodes of the transistor reaches a bottom, in response to the measured time period reaching the predetermined time period.

5. A power supply circuit configured to generate an output voltage from an alternating current (AC) voltage, the power supply circuit comprising:
an inductor configured to receive a rectified voltage corresponding to the AC voltage;
a transistor configured to control an inductor current flowing through the inductor; and
a switching control circuit configured to control switching of the transistor, the switching control circuit including
a detection circuit configured to detect whether the inductor current has reached a predetermined value;
a timer circuit configured to measure a time period after the inductor current has reached the predetermined value; and
a driver circuit configured to
turn on the transistor, in response to a number of times that the inductor current has reached the predetermined value reaching a predetermined number of times, and
turn off the transistor, in response to an ON-period that corresponds to the output voltage having elapsed,
the driver circuit being further configured to turn on the transistor, in response to the measured time period reaching a first predetermined time period, when an effective value of the AC voltage is a first level, and
turn on the transistor, in response to the measured time period reaching a second predetermined time period shorter than the first predetermined time period, when the effective value of the AC voltage is a second level higher than the first level.
